(19) United States
(12) Patent Application Publication
(10) Pub. No.: US 2010/0119136 A1
(43) Pub. Date: May 13, 2010

(54) MAGNETIC RESONANCE IMAGING APPARATUS AND IMAGE CLASSIFICATION METHOD

(76) Inventors: Hiroyuki Itagaki, Tokyo (JP); Takashi Nishihara, Tokyo (JP)

Correspondence Address: COOPER & DUNHAM, LLP, 30 Rockefeller Plaza, 20th Floor, NEW YORK, NY, 10112, US

(21) Appl. No.: 12/598,168

(22) PCT Filed: Apr. 22, 2008
(86) PCT No.: PCT/JP2008/057712

§ 371 Date: Oct. 29, 2009

(30) Foreign Application Priority Data
May 9, 2007 (JP) 2007-124608

(51) Int. Cl. G06K 9/00; G06K 9/62

(52) U.S. Cl. 382/131; 382/224

(57) ABSTRACT

A plurality of images obtained by multi-station imaging are classified.

A plurality of images are obtained by multi-station imaging on a per-station basis and classified by different image types.

Based on the classification result, the plurality of images are displayed in a predetermined format.

### TECHNICAL FIELD

The present invention relates to a magnetic resonance imaging apparatus capable of imaging a wide region of an object to be examined by dividing the object into a plurality of regions.

### BACKGROUND ART

Among magnetic resonance imaging apparatuses (hereinafter referred to as MRI apparatuses), there is a kind comprising the multi-station imaging method which performs imaging by dividing an object into a plurality of regions (hereinafter referred to as stations and multi-station imaging), synthesizes the images being imaged in the respective stations (hereinafter referred to as station images) for each image type, and reconstructs images of a wide region of the object.

In multi-station imaging, a wide region of an object can be imaged for each image type by imaging plural types of images, for example, a T1 weighted image, T2 weighted image and proton intensity image in the respective stations to obtain a station image, and synthesizing the obtained station images (for example, Non-patent Document 1).

In usual MRI apparatuses, the imaging region has been limited to a head region, etc. for imaging a plurality of image types. Therefore, the number of images per region has been low, for example 10 images, and classification or rearrangement of images would not have been a burden to an operator even they had to be carried out manually.

However, since the number of images are many in the multi-station method for imaging in a plurality of stations, it is desirable that the classification and rearrangement of images are executed by the MRI apparatus to reduce the burden of the operator. For example, in the cases such as juxtaposing and displaying a T1 weighted image and T2 weighted image, the number of images to be read in increases enormously and the procedure for selecting the necessary series of images and rearranging the displayed images becomes complicated. For this reason, if the MRI apparatus can perform classification and rearrangement of images, the burden of the operator can be greatly reduced.

In Patent Document 1, an example is disclosed which displays a plurality of station images by sequences, stations or slices by setting so that a head image is to be displayed on the upper part of the screen and a leg image on the lower part of the screen. Also, Patent Document 2 discloses the technique capable of changing the layout of screen display by using a variety of information associated with the images.

Patent Document 1: WO2006-134958

Patent Document 2: JP-A-2004-33381

Non-Patent Document 1: Japanese Journal of Radiology, Vol. 61, No. 10, pgs. 21-22, 2001

### DISCLOSURE OF THE INVENTION

### Problems to be Solved

In the multi-station imaging method, when a plurality of images are read in to be synthesized or compared, classification of images is a crucial technique from the viewpoint of improving operability since the images of a plurality of image types and stations need to be classified.

However, Patent Document 1 only discloses the user interface for displaying a plurality of station images simply by sequence, station or slice in a predetermined display order, and the algorithm for classifying the plurality of images is not taken into consideration. Patent Document 2 displays the images having a specified index to a specified position, and the function for specifying the images referring to the imaging condition is not disclosed therein. Also, the process related to the discrimination of image types or stations is not disclosed therein either.

The objective of the present invention is to provide an MRI apparatus capable of classifying a plurality of images obtained by multi-station imaging, considering the above-described circumstance.

### Means to Solve the Problem

In order to solve the above-described problem, the MRI apparatus of the present invention is characterized in comprising:

an image acquisition unit configured to divide an imaging region of an object to be examined into a plurality of stations, and obtain a plurality of images having different image types for each imaging station;

a classification processing unit configured to classify the plurality of images by image types; and

display control unit configured to display the plurality of images by image types in a predetermined display format based on the classification result by the classification processing unit.

Also, the image classification method of the present invention is characterized in classifying a plurality of images which are obtained for each station using the method which divides the object into a plurality of stations, by image types, and displaying the plurality of images in a predetermined format based on the classification result.

### EFFECT OF THE INVENTION

In accordance with the present invention, it is possible to improve the operability of the MRI apparatus by providing the function capable of classifying the plurality of images obtained in multi-station imaging and simplifying the process to be operated by an operator upon synthesizing or comparing the obtained images.

### BRIEF DESCRIPTION OF THE DIAGRAMS

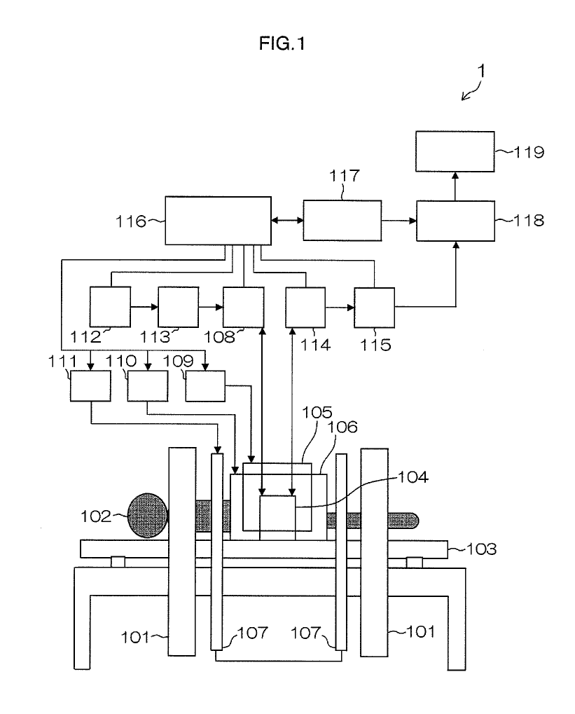

FIG. 1 is a general external view of MRI apparatus 1 related to the present invention.

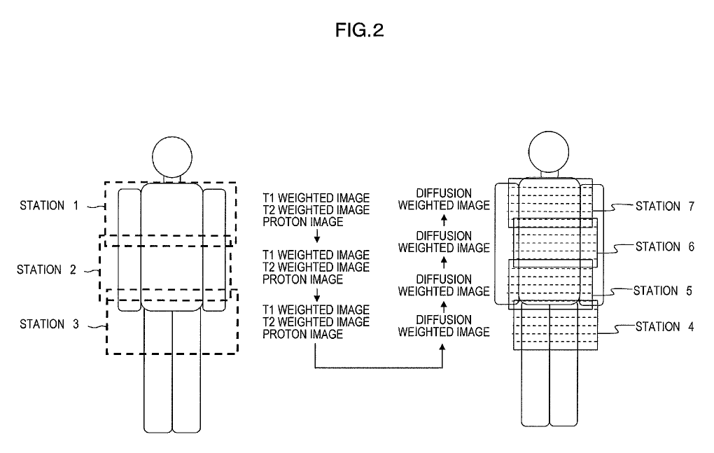

FIG. 2 shows the imaging order in the whole-body MRI.

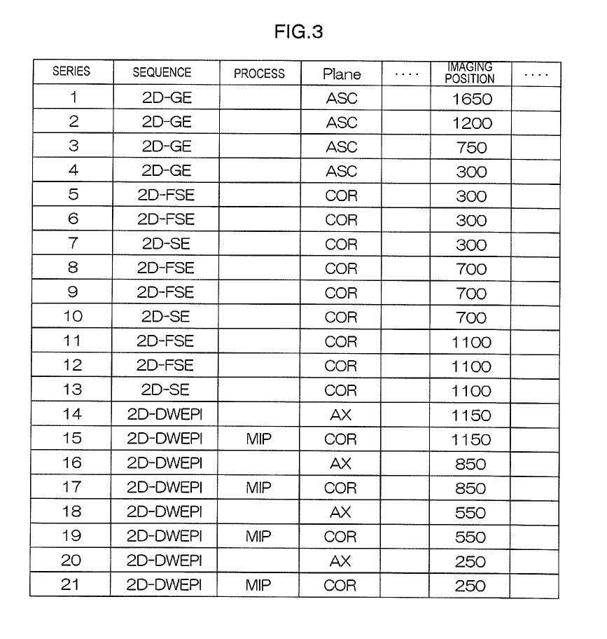

FIG. 3 shows the condition that a whole-body MRI image is being stored.

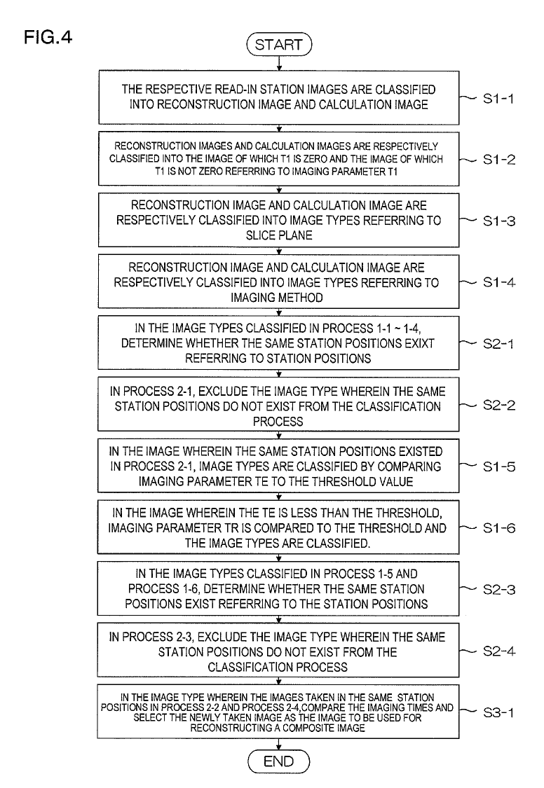

FIG. 4 is a flowchart showing the flow of automatic classification algorithm process in first embodiment of a whole-body MRI.

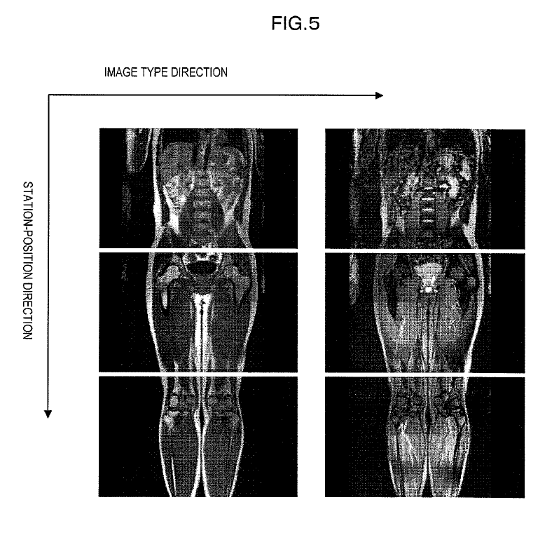

FIG. 5 is an example of a display by image types in a whole-body MRI.

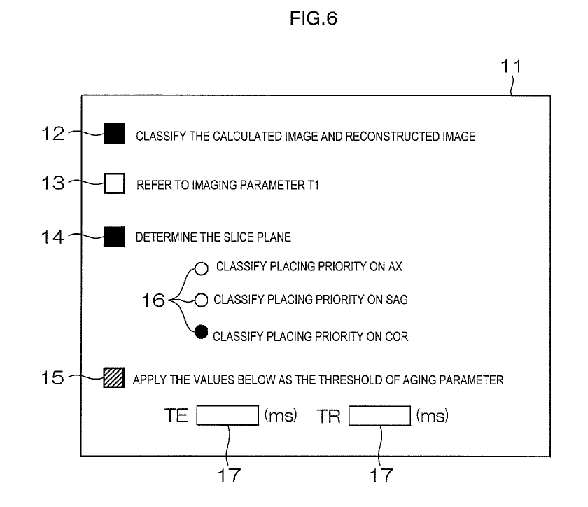

FIG. 6 is an example of a screen on which the optimization of automatic classification order in a whole-body MRI is displayed.

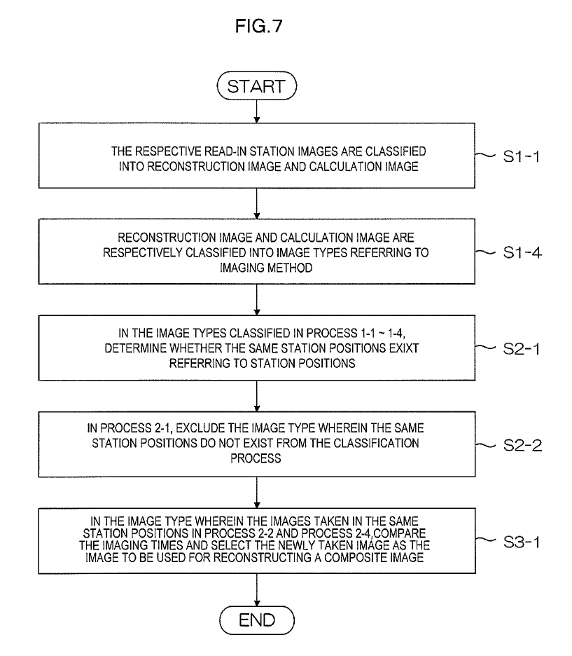

FIG. 7 is a flowchart showing the flow of automatic classification algorithm process in first embodiment regarding a whole-body MRI.

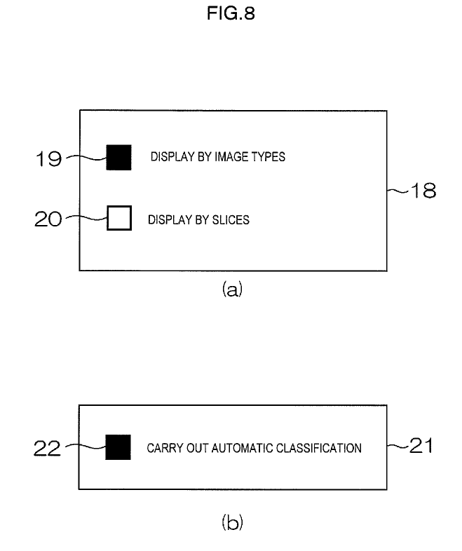

FIG. 8 is an example of a screen for selecting automatic classification functions of a whole-body MRI.

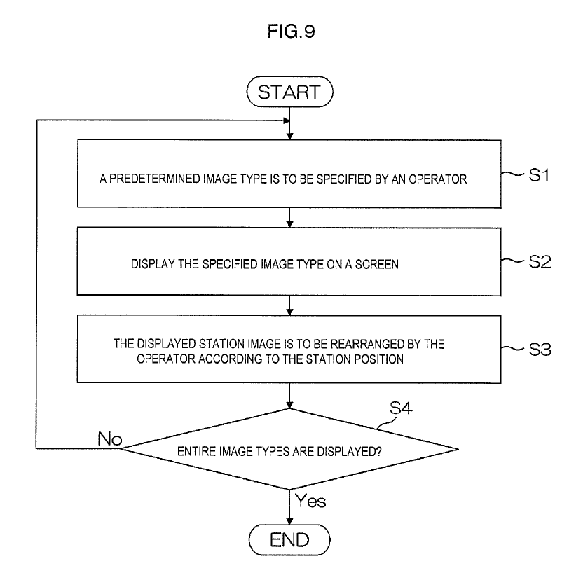

FIG. 9 is a flowchart showing the flow of an image-type display process in a conventional MRI apparatus.

### DESCRIPTION OF NUMERAL REFERENCES

1: MRI apparatus, 11: screen of the optimized automatic classification procedure, 12˜15: square button switch for specifying the priority of processing, 16: circular button switch for selecting the content of process: 17: numeric value inputting column, 18: image display method selecting screen, 19˜20: square button switch for specifying the image display method, 21: automatic classification execution selecting screen, 22: square button for specifying the execution of automatic classification, 101: static magnetic field generating magnet, 102: object, 103: bed, 104: high-frequency magnetic field coil, 105: X-direction gradient magnetic field coil, 106: Y-direction gradient magnetic field coil, 107: Z-direction gradient magnetic field coil, 108: high-frequency magnetic field source, 109: X-direction gradient magnetic field coil, 110: Y-direction gradient magnetic field coil, 111: Z-direction gradient magnetic field coil, 112: synthesizer, 113: modulator, 114: amplifier, 115: receiver, 116: sequencer, 117: storage media, 118: computer, 119: display

### BEST MODE FOR CARRYING OUT THE INVENTION

The best mode for carrying out the present invention will be described below on the basis of the attached diagrams.

FIG. 1 is a general external view of MRI apparatus 1 to which the present invention is applied. MRI apparatus 1 is mainly configured by magnet 101 which generates a static magnetic field, bed 103 for placing object 102, RF coil 104 for irradiating a high-frequency magnetic field (hereinafter referred to as RF) to object 102 and detecting an echo signal (transmits a high-frequency magnetic field and receives an MR signal), gradient magnetic field coils 105, 106 and 107 for generating a gradient magnetic field of slice selection, phase encode or frequency encode in X-direction, Y-direction or Z-direction respectively, RF source 108 for providing a power source to RF coil 104, gradient magnetic field sources 109, 110 and 111 for providing a current to gradient magnetic field coils 104, 106 and 107 respectively, sequencer 116 for controlling the operation of the MRI apparatus by transmitting commands to the peripheral devices such as RF source 108, synthesizer 112, modulator 113, amplifier 114 and receiver 115, storage media 117 for storing data such as imaging conditions, computer 118 for performing image reconstruction referring to the echo signal inputted from the receiver 115 and the data in storage media 117 and classification process of the present invention and display 119 for displaying the result of image reconstruction executed by computer 118.

While the RF coil executes both transmission and reception in FIG. 1 for the sake of simplification, the transmission coil and the reception coil are respectively mounted in the common MRI apparatuses. As for the reception coil, there are cases that a plurality of reception coils are juxtaposed for use.

Next, the operational procedure of the case for imaging object 102 using MRI apparatus 1 shown in FIG. 1 will be described.

In accordance with the imaging condition specified by an operator, sequencer 116 transmits a command to gradient magnetic field sources 109, 110 and 111 in compliance with a predetermined pulse sequence, and generates a gradient magnetic field in the respective directions by gradient magnetic field coils 105, 106 and 107. At the same time, sequencer 116 transmits a command to synthesizer 112 and modulator 113 to generate a RF waveform, generates the RF pulse amplified by RF source 108 from RF coil 104 and irradiates the generated RF pulse to object 102.

The echo signal produced from object 102 is received by RF coil 104, amplified by amplifier 114 and A/D converted and detected in receiver 115. The center frequency to be the reference for detection is read out from sequencer 116, since the previously measured value thereof is kept in storage media 117, and set in receiver 115. The detected echo signal is transmitted to computer 118 and executed with image reconstruction process. The result of the process such as image reconstruction is displayed on display 119.

Next, the case of imaging a wide region of object 102 by the multi-station imaging method using MRI apparatus 1 will be described referring to FIG. 2.

First, a T1 weighted image, T2 weighted image and proton image are imaged in station 1 in which a chest region is set as a region of interest. After imaging is completed in station 1, bed 103 is moved to station 2 in which an abdominal region is set as a region of interest, and a T1 weighted image, T2 weighted image and proton image are imaged in station 2. After imaging is completed in station 2, imaging is executed in station 3 in which a lower extremity is set as a region of interest, in the same manner as station 2.

When the imaging of the T1 weighted image, T2 weighted image and proton image is completed in all of the station positions, a diffusion weighted image is obtained from the lower extremity to the chest region in order. Generally, imaging of diffusion weighted images are influenced by inhomogeneity of static magnetic field, etc. and the station width in the body-axis direction needs to be set narrower compared to T1 weighted images, T2 weighted images and proton images, thus the number of stations need to be increased. In the case of executing the imaging shown in FIG. 2, there are diffusion weighted images for 4 stations, while there are T1 weighted images, T2 weighted images and proton images for 3 stations respectively.

In any stations, there are cases that the imaging needs to be executed again due to reasons such as body artifacts mixed in the image. In such cases, there will be a plurality of images having the same image type in the same station.

It also is possible to obtain a calculation image from the reconstruction images such as a T1 weighted image, T2 weighted image, proton image or diffusion weighted image. Calculation images are constructed by performing calculation process using a plurality of reconstruction images such as an MIP (Maximum Intensity Projection) image or difference image, and displaying the calculation result as an image.

The plurality of images obtained by the above-described method are registered in the database as shown in FIG. 3. FIG. 3 shows an example of the database indicating the disaggregated data of the image in the case of obtaining the images shown in FIG. 2 and the images for 4 stations to determine the positions for acquiring an image. The image to be displayed is specified using the above-mentioned database. Here, series 1˜4 are the images for determining positions, and the imaging planes are AX-plane, SAG-plane and COR-plane. Also, series 5˜13 are the proton images (FSE method, TR 3000 ms, TE 36 ms), T2 weighted images (FSE method, TR 5000 ms, TE128 ms) and T1 weighted images (SE method, TR 450 ms, TE 8 ms) obtained in stations 1˜3 in the imaging described using FIG. 2.

In FIG. 2, an MIP image is reconstructed from the diffusion weighted image. MIP images are generated by imaging, for example, 80 slices of AX images and projecting the reconstructed images on the COR plane. Since the reconstruction process of MIP images is performed right after the imaging of AX images, AX images of the diffusion weighted image (2D-DWEPI) and the COR images of MIP are registered alternately on the database as shown in FIG. 3. Therefore, series 14 is the diffusion weighted image in station 4, and series 15 is the MIP image in station 4. In the same way, series 16 and 17 are the diffusion weighted image and MIP image in station 5, series 18 and 19 are the diffusion weighted image and MIP image in station 6, and series 20 and 21 are the diffusion weighted image and MIP image in station 7.

Next, classification and rearrangement of such imaged reconstruction images or calculation images will be described. First, the conventional method for classification and rearrangement of images will be described using FIG. 9. The unclassified images had been manually rearranged by an operator in the conventional method. The image which is equivalent to the desired image type of the operator (for example, a T1 weighted image) is selected using the chart as shown in FIG. 3 (step S1), the image of the selected image type is displayed on a screen (step S2), and the displayed images are rearranged on the screen in a desired order (for example, according to the station positions) (step S3). The conventional method of classification and rearrangement had been carried out by repeatedly executing the above-mentioned procedure until image type which is necessary for diagnosis is displayed (step S4).

Such manual method of classification and rearrangement of images becomes a heavy burden for the operator especially in the case of using the multi-station imaging method for imaging a wide region of an object or the case of juxtaposing and displaying the images of a plurality of image types, since great number of images need to be classified and rearranged. Therefore, it is desirable that the MRI apparatus executes the classification and rearrangement of images automatically for the purpose of reducing the workload of the operator.

The classification of the plurality of images obtained by the multi-station imaging method and the rearrangement of the images thereof using the classification result related to the present invention will be described below. First, the algorithm for achieving classification of the reconstruction images or calculation image (hereinafter referred to as automatic classification algorithm) will be described.

Automatic classification algorithm executes mainly three kinds of discrimination process. First process is to discriminate image types (steps S1-1˜S1-6) which requires the most complicated process among the three kinds of discrimination process. Second is the discrimination of station positions (steps S2-1˜S2-4). These processes correspond to the lateral axis and longitudinal axis respectively in the display format on which the classified images are to be displayed. The third is the discrimination of imaging times (step S3-1). This process corresponds to the case that the imaging is performed anew in the same image type and the same station position, attributed to a reason such as movement of the object during imaging or generation of artifacts in the image.

The characteristic of the classification process of the present invention is that the discrimination of image types are executed several times, the discrimination of the station positions and the imaging times are applied after the classification of the image types for each discrimination process is completed, then a detailed image classification is to be applied only to the image type of which the classification is determined to be incomplete. This is to reduce redundancy attributed to excessively complicated discrimination process and increase of processing time for the case of changing the imaging condition for each station.

### First Embodiment of Automatic Classification Algorithm

The typical automatic classification algorithm in the present invention will be described based on the flowchart in FIG. 4. In the present invention, the automatic classification algorithm is to be applied to the respective station images specified by the operator. Therefore, “START” in the flowchart of FIG. 4 means to specify the station image to which the automatic classification algorithm is to be applied.

First, the respective station images specified by the operator are classified into the reconstruction image and the calculation image (step S1-1). Reconstruction images are generated by applying the imaging filter such as Fourier transformation and smoothing or edge enhancement, and calculation images are generated by performing calculation process using a plurality of reconstruction images such as an MIP image or difference image and displaying the calculation result as an image. This type of classification refers to, for example, the value of a private tag of DICOM. The classification can be carried out by referring to the record of information remained in a tag of a calculation image which indicates what type of process has been performed on the image thereof.

Next, with respect to the reconstruction image and calculation image, the image wherein the T1 value is other than zero and the image wherein the T1 value is zero are classified referring to the value of inversion time T1 which is the imaging parameter (step 1-2). Hereinafter, the reconstruction image of which the T1 value is other than zero is referred to as an IR image, and the reconstruction image of which the T1 value is zero is referred to as a non-IR image. All of the imaging parameters of this classification and later is referred to the value of DICOM tag. Then the respective calculation images and reconstruction images are classified into an axial plane, sagittal plane and coronal plane referring to the slice plane which is one of the imaging parameters (step S1-3), and further classification is executed referring to the imaging method which is one of the imaging parameters (step S1-4). As for the imaging method, for example, SE (Spin Echo) method or EPI (Echo Planar Imaging) method are commonly known.

The above-described process from step S1-1˜step S1-4 are set as the first stage in the discrimination process of image types. The order of above-described steps S1-1˜S1-4 does not have to be limited thereto. However, the above-described order of process is optimized considering the points below.

Point 1: since calculation images are generated using the reconstruction images, the classification of the calculation images and reconstruction images will not be executed in the case that the classification by imaging method is performed first.

Point 2: the types of calculation images are less than the types of reconstruction images.

After step S1-4 is completed, whether the reconstruction images or calculation images having the same station position exist or not is confirmed with respect to the classified image types respectively referring to the station position (step S2-1). The image type wherein the reconstruction images or the calculation images having the same station positions were found in step S2-1 is determined as the station image of which the classification is completed, and excluded from the subsequent classification process (step S2-2).

Here, the cases below can be expected in regard to the image type in which the reconstruction images or the calculation images existed:
(1) Using the same imaging method, different image types are acquired.
(2) The imaging is executed again since an artifact is mixed in the image.

Here, the case (1) needs more detailed classification of the image type, and the case (2) needs the determination on which image should be selected. When the both processes are compared, the process of the case (1) is to be prioritized since it is significant to accurately execute the classification of image types. Therefore, second stage of the discrimination process of image types as below is to be carried out after step S2-2.

In the image type where the same station positions existed in step S2-1, the reconstruction images and calculation images are classified by comparison to a predetermined threshold referring to the value of imaging parameter TE (echo time) (step S1-5). In the image type where the TE was less than the threshold value in step S1-5, the reconstruction images and calculation images are classified by comparison to a predetermined threshold referring to the value of imaging parameter TR (repetition time) (step S1-6).

The process related to the case (1) is now completed. In the same manner as step S1-1˜step S1-4, the order of process in step S1-5 and step S1-6 does not have to be limited to the order described above, but the above-described order is optimized considering the points below.

Point 3: In the image type classification process, classification of proton images, T1 weighted image and T2 weighted image are assumed to be executed. Since there are few cases that these images are acquired by the same imaging method, the image type classification process is not included in the interior half of steps S1-1˜step S1-4.

Point 4: Among the above-described three image types, the discrimination of TE in a T2 weighted image is to be prioritized since it is the easiest discrimination process.

Point 5: There are cases that the synchronous imaging is performed in the chest region or abdominal region and the images are obtained by different TR among the chest region, abdominal region and lower extremity region, thus the process referring to the value of imaging parameter TR is to be executed in the last process of image type classification.

In the respective image types classified in step S1-5 and step S1-6, the existence of the reconstruction images or the calculation images having the same station positions is to be confirmed again referring to the station position (step S2-3). The image type which did not have the reconstruction images or the calculation images having the same station positions in step S2-3 are determined as the station image of which the classification is completed (step S2-4). On the other hand, the process related to the determination of the case (2) is to be applied to the image type which had reconstruction images or the calculation images having the same station positions existed. More specifically, in the image type having the same station positions, the imaging times with respect to the plurality of reconstruction images and the calculation images obtained in the same station positions are compared, and the image which is obtained later is selected as the image to be used for display or generation of a composite image (step S3-1).

The automatic classification process is now completed. FIG. 5 shows the automatically displayed image in accordance with the preset display format. Hereinafter, the display method shown in FIG. 5 will be referred to as the image-type display. As for the image-type display, as shown in FIG. 5, the pattern to display from the vertex to the lower extremity in the top-to-bottom direction and to display by types of T1 weighted image and T2 weighted image in the horizontal direction is useful.

In accordance with the automatic classification process of the present embodiment, it is possible to achieve the image display as shown in FIG. 5 by only executing the first operation in the flowchart of FIG. 9 showing the conventional example. Also, since various types of images are to be classified before being displayed, as disclosed in Patent Document 1, it is possible to obtain the desired image-type display quickly by setting the feature quantity indicating the lateral axis and horizontal axis of the image-type display (or display format). In this manner, the operation to be executed is reduced which lowers the workload of the operator.

Since all of the processes capable of executing automatic image classification in most of the circumstances is included in the process in FIG. 4, it is not necessary to execute all of the processes at all times. It also is possible to determine the examination to be executed using the multi-station imaging method and the imaging method to be applied, for lowering the priority or even to exclude unnecessary processes. Lowering the priority means to execute the process in the posterior half of the procedure.

The method for selecting and executing only the necessary process will be described below.

FIG. 6 shows an example of the screen of the optimized automatic classification procedure. The adjustment of the screen by each examination or each facility (for example, by each hospital) is performed on the screen as shown in FIG. 6. Reference number 11 indicates the window for the screen showing the optimized classification procedure, reference numbers 12˜15 indicate the square button switches for specifying the priority of the process and reference number 17 indicates the input box of the imaging parameter.

Selection of the process is to be executed by selecting square button switches 12, 13, 14 and 15. In FIG. 6, the process of black square button switches 12 and 14 have a high priority, hatching square button switch 15 has a moderate priority, and white square button switch 13 is the case that the process is not to be executed. This is the case that the classification of the calculation image and the reconstruction image (square button switch 12) and the determination process of the slice plane (square button switch 14) are selected.

The process related to the determination of slice plane indicated by square button switch 14 which is the selection of further detailed process is executed by specifying the priority items using circular button switches 16. FIG. 6 is the case that the classification is executed by prioritizing the image type of which the slice plane is COR plane. Also, in the process for specifying the threshold value of the imaging parameter indicated by the square button switch 15, the classification is to be executed in accordance with the numerical value inputted to the input box 17.

Also, a display format can be set using FIG. 6. The lateral axis of the display format to be the base of the image-type display shown in FIG. 5 indicates the image type (refer to the result of the first discrimination) and the longitudinal axis indicates the station position (refer to the result of the second discrimination). While the setting is generally as shown in this pattern, the longitudinal axis and the lateral axis of the display format can be set by setting the result of the process inputted/set in FIG. 6 as feature quantity.

### Second Embodiment of Automatic Classification Algorithm

While the first embodiment of the automatic classification algorithm is for collectively classifying various types of images, the second embodiment of the automatic classification algorithm is for classifying images in the case that the images of the object are obtained in the images types below. In the explanation below, the portions that are the same as the first embodiment will be appended with the same symbols and the explanation thereof will be omitted.
(a) T1 weighted image: Multi-slice imaging of COR plane by the SE method (hereinafter referred to as T1 image data)
(b) T2 weighted image: Multi-slice imaging of COR plane by the FSE method (hereinafter referred to as T2 image data)
(c) Diffusion weighted image: Multi-slice imaging of AX plane by the EPI method, applied with MIP processing. On this occasion, MIP image of COR plane is generated by projecting the AX image to COR plane (hereinafter referred to as MIP image data)

The station positions of the above-mentioned three image types, i.e., T1 image data, T2 image data and MIP image data and the respective image data are to be classified. This is the case that only button switch 12 in FIG. 6 for controlling the classification of the calculation image and the reconstruction image is selected. By this operation, the process for determining imaging parameter T1 (step S1-2), the process for determining a slice plane (step S1-3) and the process for determining imaging parameters TE and TR (steps S1-5 and S1-6) are excluded from the flowchart shown in FIG. 4. Also, since steps S1-5 and S1-6 are excluded, the subsequent steps S2-3 and S2-4 become unnecessary. Therefore, the flow of the classification process of image type for this case turns out to be as the one shown in FIG. 7.

The flow of the process in the second embodiment of the automatic classification algorithm will be described below based on the flowchart in FIG. 7.

First, T1 image data and T2 image data are classified into the reconstruction image, and MIP image data is classified into the calculation image (step S1-1). T1 image data and T2 image data classified as a reconstruction image are recognized as two different image types by step S1-4 which determine the imaging method (step S1-4). In the same manner, MIP image data classified into a calculation image is recognized as one kind of image type in step S1-4 which determines the imaging method (S1-4). As stated above, it is recognized that there are three kinds of image types in step S1-1˜step S1-4.

In the respective three image types, the existence of the same station positions is determined referring to the station position (step S2-1). In the case that the redundant imaging due to the factor such as a body motion of the object does not happen, the station positions do not overlap in one image type. Therefore, such case is excluded from the classification process (step S2-2). For example, in the case that the imaging in the specified station is executed twice due to a body motion of the object upon the diffusion weighted imaging, it is recognized by step S2-1 that the same station positions exist. Since this case is not applicable to the exclusion from the classification process in step S2-2, the imaging times are compared in relation to the two image data in the same station positions, and the image data having the later imaging time is selected as the image data to be used for the generation of a composite image (step S3-1).

As it is described above using the example of obtaining a T1 weighted image, T2 weighted image and diffusion weighted image, in accordance with the present invention, it is possible to classify the station positions and image types even when image data of a plurality of image types and a plurality of station positions are specified at once, whereby operability in generating composite images can be improved.

The description above is the example of the case that only classification control of the calculation image reconstruction is selected using the button switch shown in FIG. 7. The classification result is the same even in the case that all of the classification control is selected by the button switches. In order to save the processing time, it is desirable to specify the process using the button switches in FIG. 6 so that only necessary process is to be executed.

As stated above, by using processing order of automatic classification shown in FIGS. 4 and 7 and the optimized screen regarding the automatic classification procedure shown in FIG. 6, the operation necessary from the completion of multi-station imaging to the generation of composite images can be simplified. Also in the case that the images of plural image types are inputted at once, since the image classification is executed automatically, the operator's operation for selecting the image types by discriminating images or for specifying the order of images according to the station positions become unnecessary whereby simplifying the process upon synthesizing or comparing the images and improving the operability of the apparatus. Also, since the classification can be executed simply and quickly, screening examination of a blood clot or metastasis of a tumor can be performed easily.

While the display by stations is described as image display and the automatic classification function is described as a default function in the above illustration, the classification function in the present invention does not have to be limited to the example thereof. For example, in the case that “display by image types” of the screen display in FIG. 8(a) is highly prioritized, the present invention may be set as applicable under the condition of the display by slices, by making it possible to select the display by slices which displays the images from the vertex to the lower extremity in the vertical direction and the multi-slice images of the specified image type in the lateral directions. Or, applying or not applying the automatic classification function may be set as selectable using the selecting screen in FIG. 8 (b). When the automatic classification function is not to be applied, it may be set so that the automatic classification process is executed when the setting of display format is inputted via the selecting screen in FIG. 8(a) and the images are displayed by image types. The operation method on the selecting screen of FIG. 8 is the same as the one in the screen of the optimized automatic classification procedure shown in FIG. 6.

1. A magnetic resonance imaging apparatus comprising:
an image acquisition unit configured to divide an imaging region of an object to be examined into a plurality of stations, and acquire a plurality of images having different image types for each station; and
a display control unit configured to display the plurality of images in a predetermined display format,
characterized in further comprising a classification processing unit configured to classify the plurality of images by image types,
wherein the display control unit displays the plurality of images in a predetermined display format by image types based on the classification result by the classification processing unit.

2. The magnetic resonance imaging apparatus according to claim 1, wherein:
the image acquisition unit acquires the plurality of images by varying the imaging parameters;
the classification processing unit classifies the plurality of images by the imaging parameters; and
the display control unit displays the plurality of images by the imaging parameters.

3. The magnetic resonance imaging apparatus according to claim 2, wherein the classification processing unit classifies the plurality of images based on at least one of the imaging parameters including inversion time (TI), slice plane, imaging method, echo time (TE) and repetition time (TR).

4. The magnetic resonance imaging apparatus according to claim 1, wherein:
the classification processing unit classifies the plurality of images by station positions; and
the display control unit displays the plurality of images by station positions.

5. The magnetic resonance imaging apparatus according to claim 1, wherein the classification processing unit classifies the plurality of images from a plurality of perspectives.

6. The magnetic resonance imaging apparatus according to claim 5, characterized in that the plurality of perspectives include the perspective of the imaging parameters and the perspective of the station positions.

7. The magnetic resonance imaging apparatus according to claim 1, wherein:
the image acquisition unit has a reconstruction image acquisition unit configured to acquire a reconstruction image by imaging the object and a calculation image acquisition unit configured to acquire a calculation image using a plurality of reconstruction images;
the classification processing unit classifies the plurality of images into the reconstruction images and the calculation image; and
the display control unit displays the reconstruction images and the calculation image separately.

8. The magnetic resonance imaging apparatus according to claim 2, wherein the classification processing unit selects the latest image from among the plurality of images having different imaging times which are acquired in the same station positions and the same imaging parameters.

9. The magnetic resonance imaging apparatus according to claim 2 further comprising an input unit capable of setting whether or not to refer to the inversion time (TI) regarding the input of application/non-application to the classification processing of the imaging parameters, setting and classification of the threshold value of the echo time (TE) and repetition time (TR) as the classification conditions.

10. The magnetic resonance imaging apparatus according to claim 6, wherein the display control unit arranges the images having the same image types and the different station positions from the upper part toward the lower part in order of the image of a vertex to the lower extremity, and arranges the images having different image types in the horizontal direction in accordance with the predetermined display format.

11. An image classification method using a magnetic resonance imaging apparatus, which classifies a plurality of images acquired by dividing an object to be examined into a plurality of stations having:
an image type classification step that classifies the plurality of images by image types; and
a display step that displays the plurality of images in a predetermined format based on the classification result of the image type classification step.

12. The image classification method according to claim 11 characterized in further having a station position classification step that classifies the plurality of images classified by the image types by station positions, wherein the display step displays the plurality of images in a predetermined format based on the classification result of the station position classification step.

13. The image classification method according to claim 11, wherein the image type classification step classifies the plurality of images into reconstruction images and a calculation image generated using the plurality of reconstruction images.

14. The image classification method according to claim 11, wherein the image type classification step classifies the plurality of images based on at least one of the imaging parameters including inversion time (TI), slice plane and imaging method.

15. The image classification method according to claim 13 characterized, in the case that the plurality of images are classified in the same station positions in the station position classification step, in executing a step of classifying the plurality of images in the same station positions based on at least one of the echo time (TE) and repetition time (TR) and/or a step of selecting the latest image from among the plurality of images in the same station positions.
